(19) United States
(12) Patent Application Publication
(10) Pub. No.: US 2025/0373625 A1
(43) Pub. Date: Dec. 4, 2025

(54) DETECTION OF ADVERSARIAL ATTACKS

(71) Applicant: Raytheon Company, Tewksbury, MA (US)

(72) Inventors: Sudeepta Mondal, Manchester, CT (US); Ganesh Sundaramoorthi, Duluth, GA (US)

(21) Appl. No.: 18/680,427

(22) Filed: May 31, 2024

(51) Int. Cl. H04L 9/40; G06N 3/08

(52) U.S. Cl. CPC H04L 63/1416; G06N 3/08

(57) ABSTRACT

Systems, devices, methods, and computer-readable media for detecting drifted data. A method includes generating, by a trained neural network (NN), a classification for an input cyber data packet, generating, based on a state of one or more layers of the NN responsive to the input, a topological persistence diagram, determining a distance between the topological persistence diagram and a topological feature associated with the classification, and issuing an alert responsive to the distance meeting one or more criterion.

### TECHNICAL FIELD

Embodiments regard detecting drift in a cyber intrusion detection system (IDS) and alerting to detected drift.

### BACKGROUND

Neural networks (NNs) have found increased popularity as cyber intrusion detection systems (IDSs). When these systems are deployed in practice, it is important to quantify the uncertainty of the predictions in the face of real-world data which may be different from the datasets these systems are trained on. In fact, some operators require accurate NN uncertainty estimation prior to integration into fielded systems.

State-of-the-art drift detection frameworks perform poorly in identifying the drifting nature caused by rare attack categories. This is because majority of the training data is dominated by benign traffic and common attack patterns.

Autoencoders are deep learning models which are trained to reconstruct the data from the training (in-distribution) set. Autoencoders can efficiently learn the training data distribution, and therefore, have low reconstruction errors when these are invoked to reconstruct in-distribution data. However, their reconstruction errors tend to be large when they face out-of-distribution data. Thus, a reconstruction loss can be used as a metric for defining a classifier to distinguish out-of-distribution data (data that has drifted away from the training data set) from in-distribution data.

### BRIEF DESCRIPTION OF DRAWINGS

FIG. 1 illustrates, by way of example, a block diagram of an embodiment of a system for computing and organizing topological features of a trained DNN.

FIG. 2 illustrates, by way of example, a block diagram of an embodiment of a system for drift detection and out-of-domain classification avoidance.

FIG. 3 illustrates, by way of example, a graph comparing area under ROC curves for both the baseline and the system of FIG. 2 as a function of data packet size.

FIG. 4 illustrates, by way of example, a graph comparing F1-score curves for both the baseline and the system of FIG. 2 as a function of data packet size.

FIG. 5 illustrates, by way of example, a diagram of an embodiment of a method for out-of-distribution data detection.

FIG. 6 is a block diagram of an example of an environment including a system for neural network (NN) training.

FIG. 7 illustrates, by way of example, a block diagram of an embodiment of a machine in the example form of a computer system within which instructions, for causing the machine to perform any one or more of the methods or techniques discussed herein, may be executed.

### DETAILED DESCRIPTION

The following description and the drawings sufficiently illustrate teachings to enable those skilled in the art to practice them. Other embodiments may incorporate structural, logical, electrical, process, and other changes. Portions and features of some examples may be included in, or substituted for, those of other examples. Teachings set forth in the claims encompass all available equivalents of those claims.

Embodiments may be implemented in one or a combination of hardware, firmware and software. Embodiments may also be implemented as instructions stored on a computer-readable storage device, which may be read and executed by at least one processor to perform the operations described herein. A computer-readable storage device may include any non-transitory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. Some embodiments may include one or more processors and may be configured with instructions stored on a computer-readable storage device.

Embodiments improve upon prior drift detection systems. Embodiments can use one or more topology-augmented metrics to quantify if a trained NN classification can be trusted. The topology-augmented metrics can indicate a confidence in the classification.

One application area is in monitoring the performance of an NN-based cyber IDS in the presence of drifted data which may manifest in the form of adversarial attacks. Deploying such a system in practice requires out-of-distribution detection capabilities to determine when the IDS can be trusted for detecting these adversarial attacks. This task is often referred to as data drift detection in the context of cybersecurity.

Embodiments leverage topological persistence diagrams in the context of NNs trained on network traffic data. One or more topological features of the topological persistence diagrams are sensitive enough to capture the drifts introduced by adversarial attacks that are less common. Moreover, embodiments are robust at low network traffic data packet sizes, which makes it suitable for online monitoring.

Deep NNs (DNNs) are trained using a training data set. The trained DNN acts as a cyber IDS. Each training data set includes statistical properties. Data that is provided to the DNN for classification is not guaranteed to have the same statistical properties as the training data set. Any data that does not have the same statistical properties as the training data set is said to have “drifted away” from the training data set. The trained DNN cannot, reliably and accurately, classify the data that has drifted away from the training data set. The DNN thus fails to generalize to any data that has drifted away from the training data set.

It is advantageous to detect when the data has drifted away from the training data set. Detecting when the data has drifted away from the training data set provides an ability to detect when the DNN classification is not reliable and should not be trusted. However, it is difficult to know if data has drifted away from the training data in a way that makes the classification unreliable. Also, it is difficult to adapt the DNN to handle the drifted data.

Drift detection is difficult for a variety of reasons. To determine drift detection, it should be efficient so as to make detection timely, it is hard to identify which data are to be compared, there may not be access to a training data set, and it is unknown which statistics the DNN is using to make its prediction.

One or more features of topological persistence diagrams efficiently summarize statistics of an entire dataset that the DNN uses in its decision in a few vectors of low dimension. Embodiments leverage one or more of the features to determine whether the data has drifted away from the training dataset.

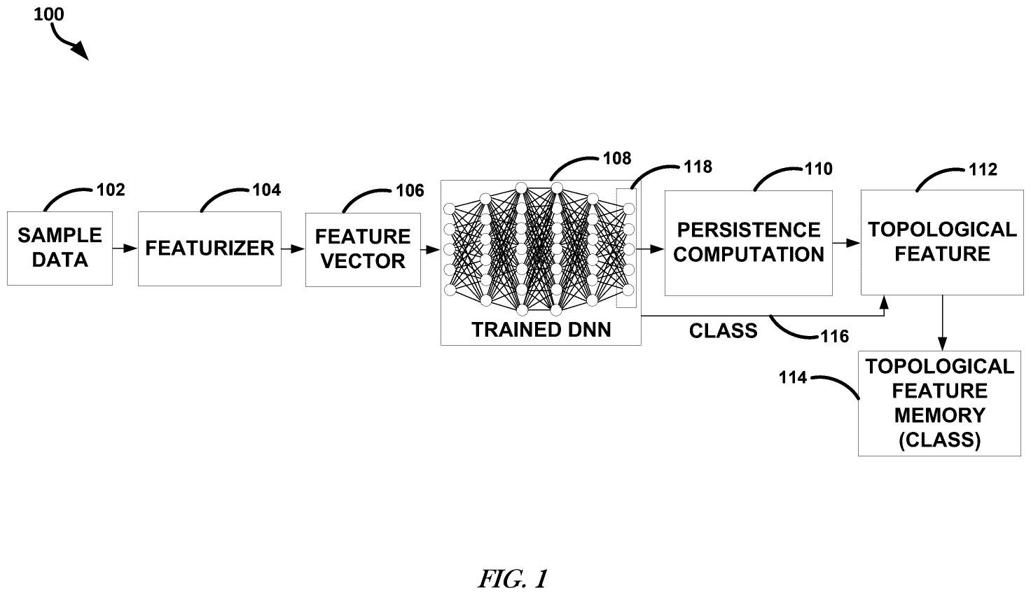

FIG. 1 illustrates, by way of example, a block diagram of an embodiment of a system 100 for computing and organizing topological features of a trained DNN 108. The system 100 as illustrated includes a trained DNN 108 that generates a classification 116. The trained DNN 108 has been trained previously and is ready for deployment or has already been deployed. The trained DNN 108 includes multiple layers of neurons including an input layer, one or more hidden layers, and an output layer. The trained DNN 108 was trained on training data that is not necessarily the same as sample data 102.

The sample data 102 is similar to the data used to train the trained DNN 108 in that the sample data 102 includes data with classifications that are the same as those provided by the trained DNN 108. The sample data 102 can include computer network traffic data in a computer network, sensor output data from a manufacturing facility, satellite or other aerial platform, or weather station, image data from a radar, lidar, optical camera, or the like, or sampled or pre-processed versions of the data. The sample data 102 can be featurized by a featurizer 104 to generate a feature vector 106. The

The featurizer 104 converts the sample data 102 into a form, the feature vector 106, that is operable by the trained DNN 108. The feature vector 106 that is an ordered list of measured, calculated, or observed phenomena in the sample data 102. The feature vector 106 is provided to the trained DNN 108 as input.

The trained DNN 108, as discussed previously, includes multiple layers including input, hidden, and output layers. A state of any of the layers responsive to the feature vector 106 input can be provided as input to a persistence computation operator 110. The trained DNN 108 can provide a classification 116 of the sample data 102 based on the feature vector 106 input.

The persistence computation operator 110 can generate a topological persistence diagram of the output layer 118. The topological persistence diagram of a neural network layer is a measure for assessing the structural complexity of the layer, which involves both the network structure and the weight information. The topological persistence diagram is used as a feature vector for drift detection. A detailed description of topological persistence is provided in “Neural Persistence: A Complexity Measure for Deep Neural Networks Using Algebraic Topology” authored by Bastian Rieck et al. and published by International Conference on Learning Representations Sep. 27, 2019.

The topological persistence diagram from the persistence computation operator 110 is provided to a topological feature operator 112. For each class in the training dataset 116, the topological feature operator 112 determines one or more average topological features that represent the class. An example topological feature is a barycenter, which is an averaged representation of the persistence diagrams from each element of a class in the training dataset. The barycenter can be computed for each class. The barycenter summarizes the average in-class statistics that a layer 1 of the trained DNN 108 uses in making decisions. There are many barycenters including Wasserstein, Kulback-Leibler, L1, among others. Denote an average topological feature as α̅_{k,l} where k denotes the index of the training classes. α̅_{k,l} is an average of the features αₗ for the training examples belonging to class k.

The topological feature operator 112 determines the features based on each of the topological persistence diagrams that are associated with a given class. Assume, for example, that the DNN generates three classes, class 1, class 2, and class 3. The topological feature operator 112 aggregates all of the topological persistence diagrams associated with class 1 into a first group, aggregates all of the topological persistence diagrams associated with class 2 into a second group, and aggregates all of the topological persistence diagrams associated with class 1 into a third group. Then the topological feature operator 112 determines the features for class 1 based on the first group of topological persistence diagrams, the features for class 2 based on the second group of topological persistence diagrams, and the features for class 3 based on the third group of topological persistence diagrams. Each of the features determined by the topological feature operator 112 are then stored in a memory 114 by class (e.g., indexed by class).

The data in the memory 114 forms a basis for understanding the topology of the trained DNN by class. The data in the memory 114 can form the basis for determining whether a subsequent input to the trained DNN 108 is within the statistical distribution of inputs used to train the trained DNN 108.

The memory 114 can include a lookup table (LUT) of the topological feature data as:

TABLE 1
Example LUT for storing topological features per class

| Class | Topo. Feature 1 | Topo. Feature 2 |
|---|---|---|
| Class 1 | Feature 1 Value | Feature 2 Value |
| Class 2 | Feature 1 Value | Feature 2 Value |
| . . . | . . . | . . . |
| Class N | Feature 1 Value | Feature 2 Value |

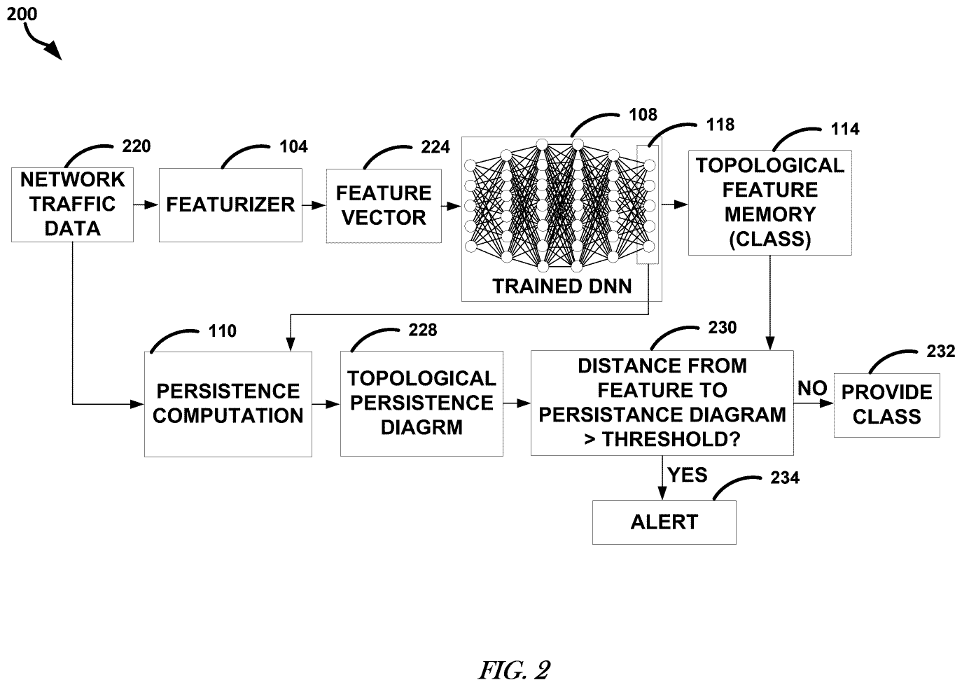

FIG. 2 illustrates, by way of example, a block diagram of an embodiment of a system 200 for drift detection and out-of-domain classification avoidance. The system 200 as illustrated includes network traffic data 220, the featurizer 104, the trained DNN 108, the topological feature memory 114, the persistence computation operator 110, a distance and comparator operation 230, and an alert operator 234. The network traffic data 220 is of the same form as the sample data 102, with the network traffic data 220 being gathered after deployment of the trained DNN 108. The network traffic data 220 is provided to the featurizer 104. The featurizer 104 generates an input feature vector 224. The input feature vector 224 includes the same structure (format and entries but likely different values) as the feature vector 106.

The input feature vector 224 is provided to the trained DNN 108. The trained DNN 108 generates a classification 116 of the network traffic data 220 associated with the input feature vector 224. The classification 116 is used as an index into the topological feature memory 114. The one or more features that are associated with the classification 116 are retrieved for determining a distance at operation 230.

The persistence computation operator 110 generates a topological persistence diagram 228 based on the state of the output layer 118 and the network traffic data 220. At operation 230, a distance between the features from the topological feature memory 114 and the topological persistence diagram 228 are determined. The operation 230 compares the determined distance to a threshold distance. If the distance between the topological persistence diagram 228 and the features is greater than a threshold, than the network traffic data 220 is out-of-distribution (in other words has drifted away from the training data) and the classification 116 should not be trusted. In such a case, an alert operator 234 generates and provides data that indicates the classification 116 is not to be trusted. The indication that the classification is not to be trusted can include setting a confidence value associated with the classification at or below a threshold (e.g., less than 0.5), setting a flag that indicates that the classification 116 is associated with out-of-distribution data, a combination thereof, or the like. If the distance between the topological persistence diagram 228 and the features is less than the threshold, then the network traffic data 220 is within distribution and provided as the classification at operation 232.

The distance determined at operation 230 can be determined as a Wasserstein distance, for example. During the test phase, for incoming network traffic data, x₀, the corresponding feature vector αₗ(x₀) (namely, a persistence diagram) is computed, by the persistence computation operator 110, for a layer, l, of the trained DNN 108. For the given x₀, assume that the trained DNN 108 classifies x₀ into a class with label k₀.

A score based on a distance metric d is computed between the calculated feature vector of the incoming observation (persistence diagram, αₗ(x₀)), and the average feature vector (e.g., barycenter, ā_{k,l}) of class k₀. Define the score as d(αₗ(x₀), α̅_{k0,l}). Different types of distance metrics can be chosen, such as the Wasserstein distance metric, a Kullback-Leiber distance, among others.

Based on the value of the calculated score d(αₗ(x₀), α̅_{k0,l}), if it is greater than a pre-defined threshold, the alert operator 234 alters the user that the incoming observation is a drifted/out-of-distribution sample and the trained DNN 108 prediction of the class label k₀ cannot be trusted with high confidence. If the score is lower than the threshold, there is no alert of data drift and the trained DNN predictions are trusted.

Distance scores from multiple layers can be used and combined to improve accuracy of drift detection. Features from multiple layers can be combined to improve drift detection accuracy.

To test whether the system 200 operates accurately and robustly to detect out-of-distribution data, performance of the system 200 was compared to performance of a baseline approach. The baseline approach included training and testing an autoencoder. The autoencoder is a deep learning (DL) model that is trained to reconstruct data from a training dataset. An autoencoder can efficiently learn the training data distribution, and therefore, have low reconstruction errors when invoked to reconstruct in-distribution data. However, the reconstruction error of an autoencoder tends to be large when it tries to reconstruct out-of-distribution data. Thus, a reconstruction loss of the autoencoder can indicate whether data is in-distribution or out-of-distribution. The autoencoder can thus be used as a metric for defining a classifier to distinguish OOD data from in-distribution data.

The system 200 was generated by training a DNN on data from an adversarial attack dataset. The dataset chosen was the Canadian Institute of Cybersecurity (CIC) IDS 2017 (CIC-IDS2017) dataset. Some metadata of the data in the CIC-IDS2017 dataset is provided:

TABLE 1
metadata of CIC-IDS2017 dataset

| | | | % of Total |
|---|---|---|---|
| Attack Type | Category | Total | Dataset |
| Benign | Benign | 2,273,097 | 80.3 |
| Denial of Service | Distributed DoS | 128,027 | 4.5227 |
| (DoS) | (DDoS) | | |
| | DoS slowloris | 5796 | 0.2048 |
| | DoS slowhttptest | 5499 | 0.1943 |
| | DoS hulk | 231,073 | 8.163 |
| | DoS GoldenEye | 10,293 | 0.3636 |
| | Hearthbleed | 11 | 0.0004 |
| PortScan | PortScan | 158,930 | 5.6144 |
| Bot | Bot | 1966 | 0.0695 |
| Brute-Force | FTP-Patator | 7938 | 0.2804 |
| | SSH-Patator | 5897 | 0.2083 |
| Web attack | Web Attack-Brute Force | 1507 | 0.0532 |
| | Web Attack-XSS | 652 | 0.0230 |
| | Web Attack-SQL Injection | 21 | 0.0007 |
| Infiltration | Infiltration | 36 | 0.0013 |
| Total Attack | | 471,454 | |
| Total | | 2,830,743 | |

Data from the four categories that appeared the least amount in the dataset were withheld as testing data. These categories are Hearthbleed, Web Attack-SQL, Infiltration, and Web Attack-XSS. The data from the remaining categories was used to train a DNN resulting in the trained DNN 108.

The trained DNN 108 was provided feature vectors 106 corresponding to the categories of provided to it for training. The persistence computation operator 110 generated topological features for each class. An average of the topological features were stored in the topological feature memory 114.

The trained DNN was then provided input feature vectors 224 from the withheld testing data. A topological persistence diagram 228 of the trained DNN 108 responsive to the withheld data was generated. A distance between a topological feature corresponding to the class and the persistence diagram 228 was determined. The determined distance was compared to a threshold at operation 230. The area under the region of convergence (ROC) for identifying out-of-distribution data using the autoencoder (“baseline”) and the system 200 (“topological uncertainty”) was determined along with an F-1 score.

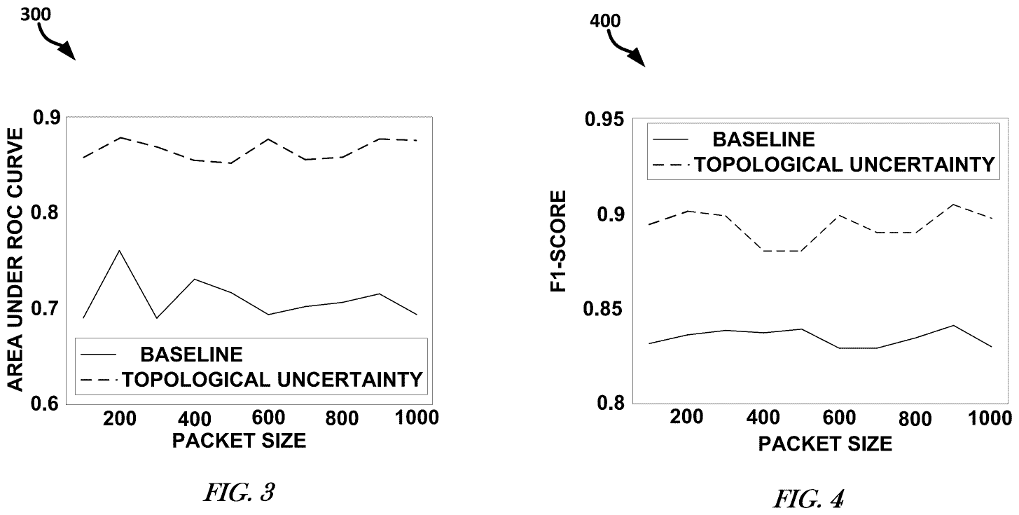

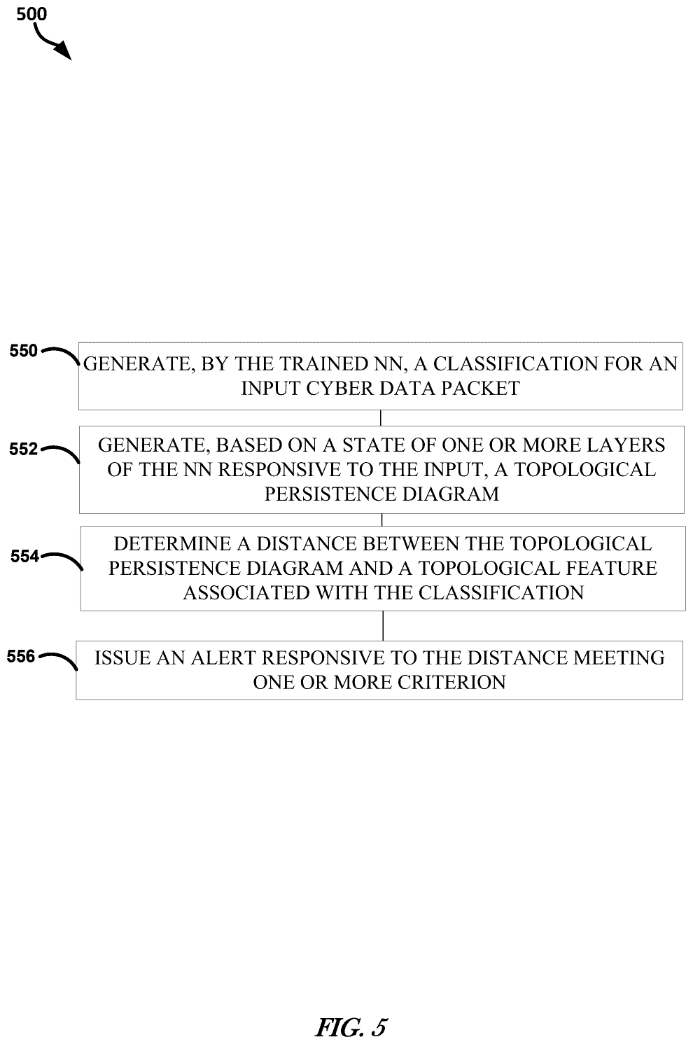

FIG. 3 illustrates, by way of example, a graph 300 comparing area under ROC curves for both the baseline and the system 200 as a function of data packet size. FIG. 4 illustrates, by way of example, a graph 400 comparing F1-score curves for both the baseline and the system 200 as a function of data packet size. High values of the area under ROC and F1-score typically indicate the effectiveness of a classifier, with a highest achievable value of one. As can be seen Results show 7% improvement on F1-score and 21% improvement of area under ROC on an average using topological metric as compared to the baseline autoencoders.

FIG. 5 illustrates, by way of example, a diagram of an embodiment of a method 500 for detecting drifted data to a cyber intrusion detection system represented by a trained neural network (NN). The method 500 as illustrated includes generating, by the trained NN, a classification for an input cyber data packet, at operation 550; generating, based on a state of one or more layers of the NN responsive to the input, a topological persistence diagram, at operation 552; determining a distance between the topological persistence diagram and a topological feature associated with the classification, at operation 554; and issuing an alert responsive to the distance meeting one or more criterion, at operation 556.

The one or more layers cab include an output layer. The criterion can include the distance being greater than a predefined threshold distance.

The method 500 can further include generating memory entries that include topological features indexed by class. Generating the memory entries can include generating topological persistence diagrams for a plurality of input data known to be associated with each classification detected by the NN. Generating the memory entries can include determining the topological feature for the classification based on all the topological persistence diagrams associated with the classification. The topological feature can be a barycenter.

The systems 100, 200, method 500, or a combination thereof can be used to identify out-of-distribution data for any DNN classifier. DNN classifiers are currently used for object recognition (e.g., military target, road object for terrestrial vehicles, aerial object for aerial vehicles, attack detection for cybersecurity applications, weather phenomenon for a weather application, general object detection for a telephone app (e.g., face recognition, plant or animal recognition, image recognition, etc.), among many other applications).

AI is a field concerned with developing decision-making systems to perform cognitive tasks that have traditionally required a living actor, such as a person. NNs are computational structures that are loosely modeled on biological neurons. Generally, NNs encode information (e.g., data or decision making) via weighted connections (e.g., synapses) between nodes (e.g., neurons). Modern NNs are foundational to many AI applications, such as classification, device behavior modeling (as in the present application) or the like. The trained DNN 108, autoencoder, or other component or operation can include or be implemented using one or more NNs.

Many NNs are represented as matrices of weights (sometimes called parameters) that correspond to the modeled connections. NNs operate by accepting data into a set of input neurons that often have many outgoing connections to other neurons. At each traversal between neurons, the corresponding weight modifies the input and is tested against a threshold at the destination neuron. If the weighted value exceeds the threshold, the value is again weighted, or transformed through a nonlinear function, and transmitted to another neuron further down the NN graph—if the threshold is not exceeded then, generally, the value is not transmitted to a down-graph neuron and the synaptic connection remains inactive. The process of weighting and testing continues until an output neuron is reached; the pattern and values of the output neurons constituting the result of the NN processing.

The optimal operation of most NNs relies on accurate weights. However, NN designers do not generally know which weights will work for a given application. NN designers typically choose a number of neuron layers or specific connections between layers including circular connections. A training process may be used to determine appropriate weights by selecting initial weights.

In some examples, initial weights may be randomly selected. Training data is fed into the NN, and results are compared to an objective function that provides an indication of error. The error indication is a measure of how wrong the NN's result is compared to an expected result. This error is then used to correct the weights. Over many iterations, the weights will collectively converge to encode the operational data into the NN. This process may be called an optimization of the objective function (e.g., a cost or loss function), whereby the cost or loss is minimized.

A gradient descent technique is often used to perform objective function optimization. A gradient (e.g., partial derivative) is computed with respect to layer parameters (e.g., aspects of the weight) to provide a direction, and possibly a degree, of correction, but does not result in a single correction to set the weight to a “correct” value. That is, via several iterations, the weight will move towards the “correct,” or operationally useful, value. In some implementations, the amount, or step size, of movement is fixed (e.g., the same from iteration to iteration). Small step sizes tend to take a long time to converge, whereas large step sizes may oscillate around the correct value or exhibit other undesirable behavior. Variable step sizes may be attempted to provide faster convergence without the downsides of large step sizes.

Backpropagation is a technique whereby training data is fed forward through the NN—here “forward” means that the data starts at the input neurons and follows the directed graph of neuron connections until the output neurons are reached—and the objective function is applied backwards through the NN to correct the synapse weights. At each step in the backpropagation process, the result of the previous step is used to correct a weight. Thus, the result of the output neuron correction is applied to a neuron that connects to the output neuron, and so forth until the input neurons are reached. Backpropagation has become a popular technique to train a variety of NNs. Any well-known optimization algorithm for back propagation may be used, such as stochastic gradient descent (SGD), Adam, etc.

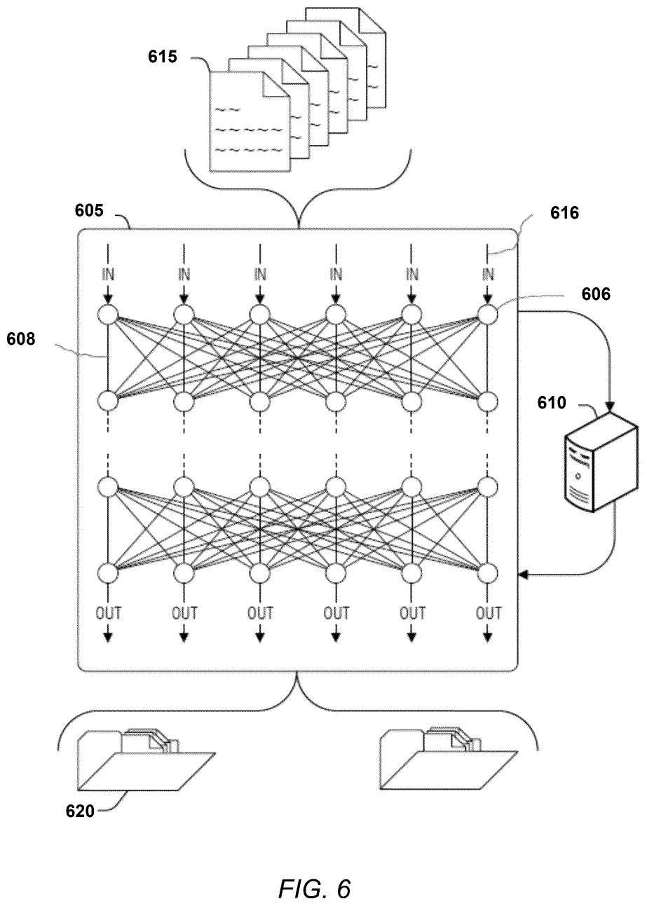

FIG. 6 is a block diagram of an example of an environment including a system for neural network (NN) training. The system includes an artificial NN (ANN) 605 that is trained using a processing node 310. The processing node 610 may be a central processing unit (CPU), graphics processing unit (GPU), field programmable gate array (FPGA), digital signal processor (DSP), application specific integrated circuit (ASIC), or other processing circuitry. In an example, multiple processing nodes may be employed to train different layers of the ANN 605, or even different nodes 606 within layers. Thus, a set of processing nodes 610 is arranged to perform the training of the ANN 305. The trained DNN 108, autoencoder, or the like, can be trained using the system of FIG. 6.

The set of processing nodes 610 is arranged to receive a training set 615 for the ANN 605. The ANN 605 comprises a set of nodes 606 arranged in layers (illustrated as rows of nodes 606) and a set of inter-node weights 608 (e.g., parameters) between nodes in the set of nodes. In an example, the training set 615 is a subset of a complete training set. Here, the subset may enable processing nodes with limited storage resources to participate in training the ANN 605.

The training data may include multiple numerical values representative of a domain, such as an image feature, or the like. Each value of the training or input 615 to be classified after ANN 605 is trained, is provided to a corresponding node 606 in the first layer or input layer of ANN 605. The values propagate through the layers and are changed by the objective function.

As noted, the set of processing nodes is arranged to train the neural network to create a trained neural network. After the ANN is trained, data input into the ANN will produce valid classifications 620 (e.g., the input data 615 will be assigned into categories), for example. The training performed by the set of processing nodes 606 is iterative. In an example, each iteration of the training the ANN 605 is performed independently between layers of the ANN 605. Thus, two distinct layers may be processed in parallel by different members of the set of processing nodes. In an example, different layers of the ANN 605 are trained on different hardware. The members of different members of the set of processing nodes may be located in different packages, housings, computers, cloud-based resources, etc. In an example, each iteration of the training is performed independently between nodes in the set of nodes. This example is an additional parallelization whereby individual nodes 606 (e.g., neurons) are trained independently. In an example, the nodes are trained on different hardware.

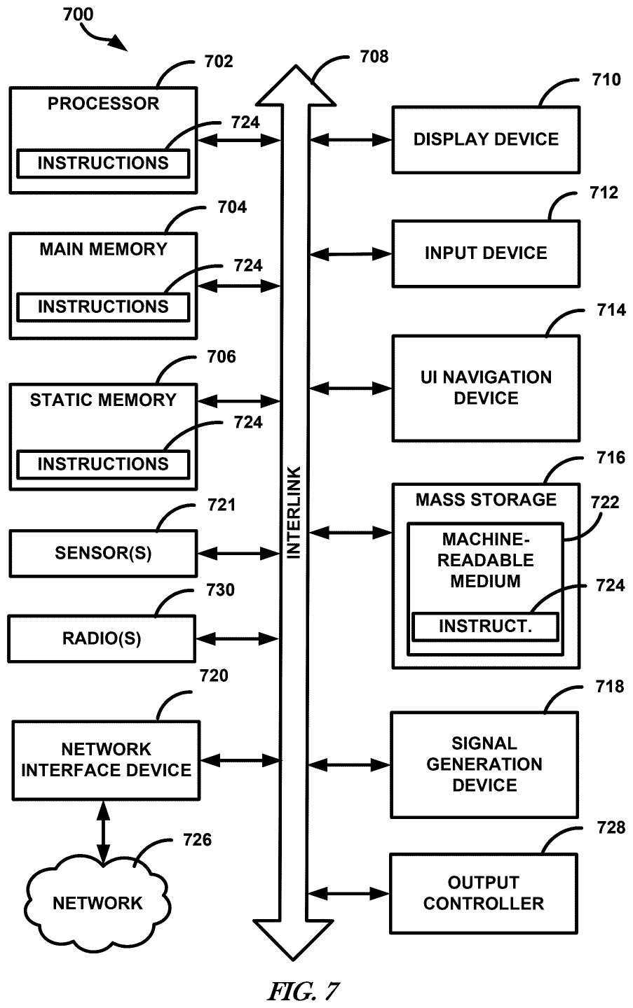

FIG. 7 illustrates, by way of example, a block diagram of an embodiment of a machine in the example form of a computer system 700 within which instructions, for causing the machine to perform any one or more of the methods or techniques discussed herein, may be executed. One or more of the featurizer 104, trained DNN 108, persistence computation operator 110, topological feature memory 114, operation 230, alert operator 234, method 500, or other component, operation, or technique, can include, or be implemented or performed by or can include one or more of the components of the computer system 700. In a networked deployment, the machine may operate in the capacity of a server or a client machine in server-client network environment, or as a peer machine in a peer-to-peer (or distributed) network environment. The machine may be a personal computer (PC), server, a tablet PC, a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU) or both), a main memory 704 and a static memory 706, which communicate with each other via a bus 708. The computer system 700 may further include a video display unit 710 (e.g., a liquid crystal display (LCD) or a cathode ray tube (CRT)). The computer system 700 also includes an alphanumeric input device 712 (e.g., a keyboard), a user interface (UI) navigation device 714 (e.g., a mouse), a mass storage unit 716, a signal generation device 718 (e.g., a speaker), a network interface device 720, and a radio 730 such as Bluetooth, WWAN, WLAN, and NFC, permitting the application of security controls on such protocols.

The mass storage unit 716 includes a machine-readable medium 722 on which is stored one or more sets of instructions and data structures (e.g., software) 724 embodying or utilized by any one or more of the methodologies or functions described herein. The instructions 724 may also reside, completely or at least partially, within the main memory 704 and/or within the processor 702 during execution thereof by the computer system 700, the main memory 704 and the processor 702 also constituting machine-readable media.

While the machine-readable medium 722 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding, or carrying instructions for execution by the machine and that cause the machine to perform any one or more of the methodologies of the present teachings, or that is capable of storing, encoding, or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

The instructions 724 may further be transmitted or received over a communications network 726 using a transmission medium. The instructions 724 may be transmitted using the network interface device 720 and any one of a number of well-known transfer protocols (e.g., HTTPS). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of encoding, or carrying instructions for execution by the machine, and includes digital or analog communications signals or other intangible media to facilitate communication of such software.

### Additional Examples

Example 1 includes a method for detecting drifted data to a cyber intrusion detection system represented by a trained neural network (NN), the method comprising generating, by the trained NN, a classification for an input cyber data packet, generating, based on a state of one or more layers of the NN responsive to the input, a topological persistence diagram, determining a distance between the topological persistence diagram and a topological feature associated with the classification, and issuing an alert responsive to the distance meeting one or more criterion.

In Example 2, Example 1 further includes, wherein the one or more layers includes an output layer.

In Example 3, at least one of Examples 1-2 further includes, wherein the criterion includes the distance being greater than a predefined threshold distance.

In Example 4, at least one of Examples 1-3 further includes generating memory entries that include topological features indexed by class.

In Example 5, Example 4 further includes, wherein generating the memory entries includes generating topological persistence diagrams for a plurality of input data known to be associated with each classification detected by the NN.

In Example 6, Example 5 further includes, wherein generating the memory entries includes determining the topological feature for the classification based on the topological persistence diagrams associated with the classification.

In Example 7, at least one of Examples 1-6 further includes, wherein the topological feature is a barycenter.

Example 8 includes a non-transitory machine-readable medium including instructions that, when executed by a machine, cause the machine to perform the method of at least one of Examples 1-7.

Example 9 includes a system for detecting drifted data, the system comprising a trained neural network (NN) configured as an intrusion detection system, the trained NN generates a classification for an input cyber data packet, processing circuitry configured to generate, based on a state of one or more layers of the NN responsive to the input, a topological persistence diagram, determine a distance between the topological persistence diagram and a topological feature associated with the classification, and issue an alert responsive to the distance meeting one or more criterion.

In Example 10, Example 9 further includes, wherein the one or more layers includes an output layer.

In Example 11, at least one of Examples 9-10 further includes, wherein the criterion includes the distance being greater than a predefined threshold distance.

In Example 12, at least one of Examples 9-11 further includes a memory that includes entries that include topological features indexed by class.

In Example 13, Example 12 further includes, wherein the processing circuitry generates the memory entries by generating topological persistence diagrams for a plurality of input data known to be associated with each classification detected by the NN and determining the topological feature for the classification based on all the topological persistence diagrams associated with the classification.

In Example 14, at least one of Examples 9-13 further includes, wherein the topological feature is a barycenter.

Although teachings have been described with reference to specific example teachings, it will be evident that various modifications and changes may be made to these teachings without departing from the broader spirit and scope of the teachings. Accordingly, the specification and drawings are to be regarded in an illustrative rather than a restrictive sense. The accompanying drawings that form a part hereof, show by way of illustration, and not of limitation, specific teachings in which the subject matter may be practiced. The teachings illustrated are described in sufficient detail to enable those skilled in the art to practice the teachings disclosed herein. Other teachings may be utilized and derived therefrom, such that structural and logical substitutions and changes may be made without departing from the scope of this disclosure. This Detailed Description, therefore, is not to be taken in a limiting sense, and the scope of various teachings is defined only by the appended claims, along with the full range of equivalents to which such claims are entitled.

What is claimed is:

1. A method for detecting drifted data to a cyber intrusion detection system represented by a trained neural network (NN), the method comprising:
generating, by the trained NN, a classification for an input cyber data packet;
generating, based on a state of one or more layers of the NN responsive to the input, a topological persistence diagram;
determining a distance between the topological persistence diagram and a topological feature associated with the classification; and
issuing an alert responsive to the distance meeting one or more criterion.

2. The method of claim 1, wherein the one or more layers includes an output layer.

3. The method of claim 1, wherein the criterion includes the distance being greater than a predefined threshold distance.

4. The method of claim 1, further comprising generating memory entries that include topological features indexed by class.

5. The method of claim 4, wherein generating the memory entries includes generating topological persistence diagrams for a plurality of input data known to be associated with each classification detected by the NN.

6. The method of claim 5, wherein generating the memory entries includes determining the topological feature for the classification based on the topological persistence diagrams associated with the classification.

7. The method of claim 1, wherein the topological feature is a barycenter.

8. A non-transitory machine-readable medium including instructions that, when executed by a machine, cause the machine to perform operations for detecting drifted data to a cyber intrusion detection system represented by a trained neural network (NN), the method comprising:
generating, by the trained NN, a classification for an input cyber data packet;
generating, based on a state of one or more layers of the trained NN responsive to the input, a topological persistence diagram;
determining a distance between the topological persistence diagram and a topological feature associated with the classification; and
issuing an alert responsive to the distance meeting one or more criterion.

9. The non-transitory machine-readable medium of claim 8, wherein the one or more layers includes an output layer.

10. The non-transitory machine-readable medium of claim 8, wherein the criterion includes the distance being greater than a predefined threshold distance.

11. The non-transitory machine-readable medium of claim 8, wherein the operations further comprise generating memory entries that include topological features indexed by class.

12. The non-transitory machine-readable medium of claim 11, wherein generating the memory entries includes generating topological persistence diagrams for a plurality of input data known to be associated with each classification detected by the NN.

13. The non-transitory machine-readable medium of claim 12, wherein generating the memory entries includes determining the topological feature for the classification based on the topological persistence diagrams associated with the classification.

14. The non-transitory machine-readable medium of claim 8, wherein the topological feature is a barycenter.

15. A system for detecting drifted data, the system comprising:
a trained neural network (NN) configured as an intrusion detection system, the trained NN generates a classification for an input cyber data packet;
processing circuitry configured to:
generate, based on a state of one or more layers of the NN responsive to the input, a topological persistence diagram;
determine a distance between the topological persistence diagram and a topological feature associated with the classification; and
issue an alert responsive to the distance meeting one or more criterion.

16. The system of claim 15, wherein the one or more layers includes an output layer.

17. The system of claim 15, wherein the criterion includes the distance being greater than a predefined threshold distance.

18. The system of claim 15, further comprising a memory that includes entries that include topological features indexed by class.

19. The system of claim 18, wherein the processing circuitry generates the memory entries by generating topological persistence diagrams for a plurality of input data known to be associated with each classification detected by the NN and determining the topological feature for the classification based on the topological persistence diagrams associated with the classification.

20. The system of claim 15, wherein the topological feature is a barycenter.
